(19) United States
(12) Patent Application Publication
(10) Pub. No.: US 2016/0002459 A1
(43) Pub. Date: Jan. 7, 2016

(54) WIPER BLADE ELEMENT

(71) Applicant: Robert Bosch GmbH, Stuttgart (DE)

(72) Inventors: Reiner Lay, Aachen (DE); Valerie Carlier, Gesves (BE); Nicolaas Gotzen, Kortenberg (BE); Vincent Duval, Bruxelles (BE); Eric Pieters, Simpelveld (NL)

(21) Appl. No.: 14/766,832

(22) PCT Filed: Jan. 15, 2014
(86) PCT No.: PCT/EP2014/050730

§ 371 Date: Aug. 10, 2015

(30) Foreign Application Priority Data
Feb. 8, 2013 (DE) 102013202114.3

(51) Int. Cl. C08L 45/00; B60S 1/38; C08L 9/00; C08L 15/02; C08L 23/22; C08L 11/00

(52) U.S. Cl. CPC C08L 45/00; C08L 23/22; C08L 11/00; C08L 9/00; C08L 15/02; B60S 1/38; C08L 2205/02; B60S 2001/3829

(57) ABSTRACT

The invention relates to a wiper blade element (10) for a wiper blade, for example of a motor vehicle. In order to minimize the running noise, said wiper blade element (10) comprises an elastomer material (A) which comprises a polymer blend from at least one ethylene-propylene-(diene)-rubber and at least one polymer, selected from the group consisting of polynorbornene, trans-polyoctenamer, polyisobutylene, chloroprene rubber, butyl rubber, chlorobutyl rubber, bromobutyl rubber and mixtures thereof. In the polymer blend, the weight ratio of ethylene-propylene-(diene) rubber and/or ethylene-propylene rubber to the at least one polymer is in a range of 40:60-95:5. The invention also relates to said type of elastomer material (A) and a wiper blade equipped with said type of wiper blade element (10).

### BACKGROUND OF THE INVENTION

The invention relates to a wiper rubber, in particular for a windshield wiper, to an elastomer material for a wiper rubber and to a windshield wiper.

Wiper rubbers of windshield wipers are used to guarantee a good view through a windshield under wet conditions.

In addition to the wiping quality which can be produced by a wiper rubber, additional properties, such as running properties, noises, and the like, are of interest with wiper rubbers for windshield wipers. For example, with conventional wiper rubbers, unpleasant running noises, such as whistles, squeaks, squelches, flipover noises, and the like, can occur when operating the windshield wipers.

The publications DE 199 44 274 A1, WO 2009/130081 A1 and DE 10 2009 001 043 A1 describe wiper rubbers for windshield wipers.

### SUMMARY OF THE INVENTION

A subject matter of the present invention is a wiper rubber, in particular for a windshield wiper, for example of a motor vehicle, comprising an elastomer material which comprises a polymer blend of at least one ethylene/propylene/diene rubber (EPDM) and/or at least one ethylene/propylene rubber (EPM) and at least one polymer chosen from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof.

A polymer blend can in particular be understood to mean a macroscopically homogeneous mixture of two or more different polymers.

A polymer blend which comprises at least one ethylene/propylene/diene rubber (EPDM) and/or at least one ethylene/propylene rubber (EPM) and at least one polymer chosen from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof is subsequently also described as EP(D)M-NOR/TOR/PIB/CR/IIR/CIIR/BIIR polymer blend.

For example, the polymer blend can comprise two or more (different) ethylene/propylene/diene rubbers and/or two or more (different) ethylene/propylene rubbers, for example with different ethylene contents and/or propylene contents and/or termonomer contents and/or termonomers, for example chosen from the group consisting of ethylidenenorbornene (ENB), vinylnorbornene (VNB), dicyclopentadiene (DCP), 1,4-hexadiene and mixtures thereof.

Alternatively or additionally thereto, the polymer blend can comprise two or more (different) polymer types chosen from the group consisting of polynorbornene, trans-polyoctenamer, polyisobutylene, chloroprene rubber, butyl rubber, chlorobutyl rubber and bromobutyl rubber and/or optionally two or more different polymers from the same polymer type from the group consisting of polynorbornene, trans-polyoctenamer, polyisobutylene, chloroprene rubber, butyl rubber, chlorobutyl rubber and bromobutyl rubber.

In addition to ethylene/propylene/diene rubber(s) and/or ethylene/propylene rubber(s) and the at least one polymer from the abovementioned group, the polymer blend can in principle furthermore comprise yet one or more other polymers, for example ethylene/vinyl acetate copolymer(s).

However, it is also possible for the polymer blend to be formed of ethylene/propylene/diene rubber(s) and/or ethylene/propylene rubber(s) and the at least one polymer from the abovementioned group.

Formed can, in this connection, in particular be understood to mean that no other polymers are present; however, other materials, such as additives may be present.

It has been shown that, for example, when pure or unblended (not blended with other polymers) ethylene/propylene/diene rubber (EPDM) is used in elastomer materials for the preparation of wiper rubbers, the wiper rubbers prepared from it can indeed exhibit a good wiping quality; however, in the operation thereof, generally loud running noises, such as whistles, squeaks, squelches, flipover noises, and the like, can also occur.

It has turned out that such running noises can be advantageously minimized or even avoided by using an elastomer material based on a polymer blend of ethylene/propylene/diene rubber (EPDM) and/or ethylene/propylene rubber (EPM) and one or more polymers from the group consisting of polynorbornene, trans-polyoctenamer, polyisobutylene, chloroprene rubber, butyl rubber, chlorobutyl rubber and bromobutyl rubber. This is presumably due to a type of deadening being introduced into the elastomer material by polynorbornene, trans-polyoctenamer, polyisobutylene, chloroprene rubber, butyl rubber, chlorobutyl rubber and bromobutyl rubber, which type of deadening reduces or even prevents the development of noise.

A noise-reducing effect can advantageously already occur with low amounts of the additional polymer. However, it has turned out that the amount of the additional polymer should not be too high since then the advantageous properties of the ethylene/propylene/diene and/or ethylene/propylene rubber, in particular the good wiping quality, decline and possibly even undesired effects can be caused by the additional polymer.

With a content of polynorbornene, trans-polyoctenamer or chloroprene rubber which is too high, the elastomer material can become too hard and the modulus of elasticity thereof too high. This can to a certain extent be counteracted by a reduction in the content of crosslinking agent. An additional aspect is the heat resistance, which advantageously even with a high content of trans-polyoctenamer or chloroprene rubber can still be sufficiently good but with an increasing polynorbornene content can worsen. In addition, an unpleasant smell can appear with a content of chloroprene rubber which is too high.

With a content of polyisobutylene, butyl rubber, chlorobutyl rubber or bromobutyl rubber which is too high, the elastomer material can on the other hand become too soft and the modulus of elasticity thereof can fall. This can in particular be due to a poor crosslinkability. The heat resistance may nevertheless be sufficiently good. In addition, an unpleasant smell may appear with a content of chlorobutyl or bromobutyl rubber which is too high.

By a combination of two or more of these polymers, in particular with opposite effects, these effects can advantageously to a certain extent be evened out.

In order to prepare a wiper rubber which exhibits an acceptable to good wiping quality and running properties and in addition generates little or no running noises, such as whistles, squeaks, squelches, flipover noises, and the like, it has turned out to be advantageous for the ratio by weight of ethylene/propylene/diene rubber and/or ethylene/propylene rubber (in total) to the at least one polymer, in particular the total weight of the at least one polymer, to lie in a region from 40:60 to 95:5 and/or for the content of the at least one polymer, that is, in the case of several polymers, the total content of the polymers (NOR/TOR/PIB/CR/IIR/CIIR/BIIR) blended with ethylene/propylene/diene rubber and/or ethylene/propylene rubber, to be at least 5% by weight and at most ≦60% by weight, based on the total weight of the polymers in the polymer blend. Thus, a wiper rubber can advantageously be prepared which can exhibit a good wiping quality and good running properties and in addition can generate little or no running noises, such as whistles, squeaks, squelches, flipover noises, and the like.

In the context of one embodiment, accordingly, in the polymer blend, the ratio by weight of ethylene/propylene/diene rubber and/or ethylene/propylene rubber (in total), in particular ethylene/propylene/diene rubber (in total), to the at least one polymer, in particular of the total weight of the at least one polymer, lies in a region from 40:60 to 95:5. In particular, in this connection, in the polymer blend, the ratio by weight of ethylene/propylene/diene rubber and/or ethylene/propylene rubber (in total), in particular ethylene/propylene/diene rubber (in total), to the at least one polymer, in particular the total weight of the at least one polymer, can lie in a region from 45:55 or 50:50 or 55:45 or 60:40 or 70:30 to 95:5 or 90:10 or 85:15 or 80:20.

In the context of a specific form of this embodiment, in the polymer blend, the ratio by weight of ethylene/propylene/diene rubber and/or ethylene/propylene rubber (in total), in particular ethylene/propylene/diene rubber (in total), to the at least one polymer, in particular the total weight of the at least one polymer, lies in a region from 50:50 to 95:5 or 90:10. This has proven to be particularly advantageous.

In the context of an additional embodiment, the polymer blend comprises, based on the total weight of the polymers in the polymer blend, ≧5% by weight to ≦60% by weight of the at least one polymer (in total).

In this connection, the polymer blend can comprise, based on the total weight of the polymers in the polymer blend, in particular ≧40% by weight to ≦95% by weight of ethylene/propylene/diene rubber and/or ethylene/propylene rubber (in total), in particular ethylene/propylene/diene rubber (in total).

For example the polymer blend can, based on the total weight of the polymers in the polymer blend, comprise ≧5% by weight or ≧10% by weight or ≧15% by weight or ≧20% by weight to ≦55% by weight or ≦50% by weight or ≦45% by weight or ≦40% by weight of the at least one polymer (in total). In this connection, the polymer blend can, based on the total weight of the polymers in the polymer blend, comprise ≧45% by weight or ≧50% by weight or ≧55% by weight or ≧60% by weight or ≧70% by weight to ≦95% by weight or ≦90% by weight or ≦85% by weight or ≦80% by weight of ethylene/propylene/diene rubber and/or ethylene/propylene rubber (in total), in particular ethylene/propylene/diene rubber (in total).

In the context of a specific form of this embodiment, the polymer blend comprises, based on the total weight of the polymers in the polymer blend, ≧5% by weight or ≧10% by weight to ≦50% by weight of the at least one polymer (in total). In this connection, the polymer blend can, based on the total weight of the polymers in the polymer blend, comprise in particular ≧50% by weight to ≦95% by weight or ≦90% by weight of ethylene/propylene/diene rubber and/or ethylene/propylene rubber (in total), in particular ethylene/propylene/diene rubber (in total). For example, the polymer blend can, based on the total weight of the polymers in the polymer blend, comprise ≧5% by weight or ≧10% by weight to ≦50% by weight of the at least one polymer and ≧50% by weight to ≦95% by weight or ≦90% by weight of ethylene/propylene/diene rubber and/or ethylene/propylene rubber (in total), in particular ethylene/propylene/diene rubber (in total). This has proven to be particularly advantageous.

The polymer blend can in principle be a polymer blend which comprises at least one ethylene/propylene/diene rubber and/or at least one ethylene/propylene rubber and at least one polymer chosen from the group consisting of polynorbornene, trans-polyoctenamer, polyisobutylene, chloroprene rubber, butyl rubber, chlorobutyl rubber, bromobutyl rubber and mixtures thereof (EP(D)M-NOR/TOR/PIB/CR/IIR/CIIR/BIIR polymer blend) or is formed therefrom, or which comprises at least one ethylene/propylene/diene rubber and at least one polymer from this group (EPDM-NOR/TOR/PIB/CR/IIR/CIIR/BIIR polymer blend) or is formed therefrom, or which comprises at least one ethylene/propylene rubber and at least one polymer from this group (EPM-NOR/TOR/PIB/CR/IIR/CIIR/BIIR polymer blend) or is formed therefrom.

In the context of an additional embodiment, the polymer blend is a polymer blend (EPDM-NOR/TOR/PIB/CR/IIR/CIIR/BIIR polymer blend) of at least one ethylene/propylene/diene rubber (EPDM) and at least one polymer chosen from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof. In particular, the polymer blend can be a polymer blend (EPDM-NOR/TOR/PIB/CR/IIR/CIIR/BIIR polymer blend) which is formed from at least one ethylene/propylene/diene rubber (EPDM) and at least one polymer chosen from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof. A higher degree of crosslinking can advantageously be achieved through ethylene/propylene/diene rubber (EPDM). In addition, ethylene/propylene/diene rubber (EPDM) can advantageously be crosslinked both with peroxides and with sulfur and can exhibit a good processability.

In the context of an additional embodiment, the at least one polymer is chosen from the group consisting of polynorbornene (NOR), trans-polyoctenamer (TOR), polyisobutylene (PIB) and mixtures thereof.

For example, the at least one polymer can be polynorbornene (NOR) and/or trans-polyoctenamer (TOR) and/or polyisobutylene (PIB). This has proven to be particularly advantageous.

Polynorbornene can be mixed, both pure and in the form of an oily mixture, for example a “polynorbornene/oil masterbatch”, with the ethylene/propylene/diene rubber and/or ethylene/propylene rubber to give the polymer blend.

In the context of a specific form, the polynorbornene is, however, a polynorbornene/oil mixture. This has in particular proven to be advantageous to the processability of the polymer blend or elastomer material. In this connection, the oil of the polynorbornene/oil mixture can in particular be a plasticizer oil or plasticizer oil mixture. The running properties and optionally running noises of the wiper rubber can advantageously be still improved by the addition of a plasticizer oil.

In particular, the (plasticizer) oil of the polynorbornene/oil mixture can be a paraffinic, naphthenic or aromatic oil, for example a mineral oil, a synthetic oil, a natural oil or an oil mixture thereof. For example, the (plasticizer) oil of the polynorbornene/oil mixture can be a mineral oil. In particular, the (plasticizer) oil of the polynorbornene/oil mixture can be a paraffinic oil, for example a highly refined paraffinic mineral oil. For example, the (plasticizer) oil of the polynorbornene/oil mixture can be a highly refined paraffinic mineral oil purified by catalytic hydrogenation. In particular, the (plasticizer) oil of the polynorbornene/oil mixture can be an oil corresponding to the EU Directive 2005/69/EC.

In the context of a specific form, the (plasticizer) oil of the polynorbornene/oil mixture exhibits a pour point in a region from ≧−25° C. to ≦+25° C., in particular from ≧−15° C. or ≧−10° C. or ≧−5° C. or ≧0° C. to ≦+25° C. or ≦+20° C. or ≦+15° C. or ≦+10° C. or ≦+5° C.

The pour point describes, according to DIN 51597, for a liquid product, the temperature at which it only just flows on cooling.

Optionally, the (plasticizer) oil of the polynorbornene/oil mixture with an abovementioned pour point can in this connection also exhibit a setting point in a region from ≧−25° C. to ≦+25° C., in particular from ≧−15° C. or ≧−10° C. or ≧−5° C. or ≧0° C. to ≦+25° C. or ≦+20° C. or ≦+15° C. or ≦+10° C. or ≦+5° C. However, it is likewise possible for the oil of the polynorbornene/oil mixture with an abovementioned pour point to exhibit a setting point which is somewhat higher than the abovementioned regions since the setting point is generally a few degrees higher than the pour point.

The setting point describes, according to DIN EN 23015 (formerly DIN 51583), the temperature at which a test sample has stopped flowing and for 10 seconds no further movement of the test sample can be recognized.

It has turned out that plasticizer oils with an abovementioned pour point and optionally also setting point particularly advantageously affect the running noise minimization. Presumably, this is also based on a type of deadening being introduced into the elastomer material by the plasticizer oil with such a pour point. It has turned out that, in this connection, the noise-reducing effect is dependent on the pour point. To achieve the noise-reducing effect, it has in this connection proven to be advantageous for a plasticizer oil with a pour point, and optionally also setting point, of at least ≧−25° C., for example ≧−15° C. or ≧−10° C. or ≧−5° C. to be used. On the other hand, it has turned out that the low-temperature flexibility and accordingly other running properties of the wiper rubber are also dependent on the pour point of the plasticizer oil. In view of this, it has in this connection proven to be advantageous for the plasticizer oil to exhibit a pour point, and optionally also setting point, of ≦+25° C., for example ≦+20° C. or ≦+15° C. or ≦+10° C. or ≦+5° C.

In the polynorbornene/oil mixture, the ratio by weight of polynorbornene to the oil can in particular be in a region from 30:70 to 70:30.

In the context of an additional embodiment, the elastomer material furthermore comprises, that is in the case of a polynorbornene/oil mixture additionally, at least one plasticizer oil.

In particular, the elastomer material can in this connection furthermore exhibit at least one plasticizer oil with a pour point in a region from ≧−25° C. to ≦+25° C., in particular from ≧−15° C. or ≧−10° C. or ≧−5° C. or ≧0° C. to ≦+25° C. or ≦+20° C. or ≦+15° C. or ≦+10° C. or ≦+5° C. As already explained in connection with the (plasticizer) oil of the polynorbornene/oil mixture, the processability and the running properties can advantageously be improved and also optionally the running noises can advantageously be minimized through the addition of a plasticizer oil.

Optionally, the at least one plasticizer oil with an abovementioned pour point can in this connection also exhibit a setting point in a region from ≧−25° C. to ≦+25° C., in particular from ≧−15° C. or ≧−10° C. or ≧−5° C. or ≧0° C. to ≦+25° C. or ≦+20° C. or ≦+15° C. or ≦+10° C. or ≦+5° C. However, it likewise possible for the at least one plasticizer oil with an abovementioned pour point to exhibit a setting point which is somewhat higher than the abovementioned regions since the setting point generally is a few degrees higher than the pour point. As already explained in connection with the polynorbornene/oil mixture, the running properties and running noises of the wiper rubber can advantageously be still improved by the addition of such a plasticizer oil.

The at least one plasticizer oil can in particular likewise be a paraffinic, naphthenic or aromatic oil, for example a mineral oil, a synthetic oil, a natural oil or an oil mixture thereof. For example, the at least one plasticizer oil can be a mineral oil. In particular, the at least one plasticizer oil can be a paraffinic oil, for example a highly refined paraffinic mineral oil. For example, the at least one plasticizer oil can be a highly refined paraffinic mineral oil purified by catalytic hydrogenation. In particular, the at least one plasticizer oil can be an oil corresponding to EU Directive 2005/69/EC. The at least one plasticizer oil can in particular be the same oil as the oil of the polynorbornene/oil mixture.

In the context of an additional embodiment, the elastomer material comprises, per 100 parts by weight of the polymer blend, ≧5 parts by weight to ≦80 parts by weight of plasticizer oil. In particular, the elastomer material can, per 100 parts by weight of the polymer blend, comprise ≧5 parts by weight to ≦80 parts by weight of plasticizer oil with an abovementioned pour point (and optionally also setting point). This has proven to be advantageous with regard to the processability and the running properties, in particular the running noise minimization.

For example, the elastomer material can comprise, per 100 parts by weight of the polymer blend, ≧5 parts by weight to ≦50 parts by weight, in particular ≧10 parts by weight to ≦45 parts by weight, of plasticizer oil.

In the context of an additional embodiment, the elastomer material comprises, per 100 parts by weight of the polymer blend, ≧5 parts by weight to ≦50 parts by weight, in particular ≧10 parts by weight to ≦45 parts by weight, of plasticizer oil with an abovementioned pour point (and optionally also setting point). This has in particular proven to be particularly advantageous for the running noise minimization.

If the at least one plasticizer oil, in particular with a pour point in a region from ≧−25° C. to ≦+25° C., is used in addition to the oil of a polynorbornene/oil mixture, the elastomer material comprises, per 100 parts by weight of the polymer blend, preferably altogether ≧5 parts by weight to ≦80 parts by weight of plasticizer oils, for example of the at least one plasticizer oil, in particular with an abovementioned pour point (and optionally also setting point), and optionally of oil of the polynorbornene/oil mixture, in total.

In addition to the at least one plasticizer oil with an abovementioned pour point (and optionally setting point), the elastomer material can still comprise one or more other plasticizer oils.

Preferably, in this connection, the content of other plasticizer oils is however, lower than or at most equal to the content of plasticizer oils with an abovementioned pour point. If other plasticizer oils are designated, it can be advantageous for the elastomer material to comprise, per 100 parts by weight of the polymer blend, altogether ≧5 parts by weight to ≦80 parts by weight of plasticizer oils, for example of the at least one plasticizer oil, in particular with an abovementioned pour point (and optionally also setting point), and other plasticizer oils, and optionally of oil of the polynorbornene/oil mixture in total.

In the context of an additional embodiment, the elastomer material furthermore comprises carbon black. For example, the elastomer material can comprise, per 100 parts by weight of the polymer blend, ≧20 parts by weight to ≦120 parts by weight of carbon black. It has turned out that a carbon black content of ≧20 parts by weight per 100 parts by weight of polymer blend is advantageous in achieving a good abrasion resistance. In order at the same time to guarantee a good processability, it has however turned out to be advantageous for the carbon black content not to be adjusted too high. To a certain extent, processability with high amounts of carbon black can be improved by addition of an oil, in particular a plasticizer oil explained in more detail above. With regard to the noise-reducing effect and the dynamic properties or running properties of the wiper rubber, it has proven to be advantageous to use, per 100 parts by weight of polymer blend, at most ≦120 parts by weight of carbon black and, as explained in more detail above, at most ≦80 parts by weight of (plasticizer) oil.

For example, the elastomer material can comprise, per 100 parts by weight of the polymer blend, ≧25 parts by weight to ≦95 parts by weight of carbon black. In particular, the elastomer material can comprise, per 100 parts by weight of the polymer blend, ≧30 parts by weight or ≧35 parts by weight to ≦90 parts by weight or ≦85 parts by weight or ≦80 parts by weight or ≦75 parts by weight of carbon black. Such carbon black contents have proven to be particularly advantageous with regard to the abrasion resistance and processability. In addition, such carbon black contents have also proven to be particularly advantageous with regard to a noise minimization.

In the context of an additional embodiment, the ratio by weight of carbon black to (plasticizer) oil lies in a region from 90:10 to 50:50, in particular in a region from 80:20 to 65:35. This has proven to be advantageous with regard to the processability and the running properties, in particular the running noise minimization. In particular, the ratio by weight of carbon black to plasticizer oil with an abovementioned pour point (and optionally also setting point) can lie in a region from 90:10 to 50:50, in particular in a region from 80:20 to 65:35. This has turned out to be particularly advantageous in achieving good running properties and little to no running noises.

In the context of one form, the polymer blend (EP(D)M-NOR/TOR/PIB/CR/IIR/CIIR/BIIR polymer blend) is an ethylene/propylene/diene rubber (EPDM)-polynorbornene (NOR) polymer blend. In this connection, the ratio by weight of ethylene/propylene/diene rubber to polynorbornene in the polymer blend can for example lie in a region from 50:50 or 55:45 or 60:40 to 95:5 or 90:10.

In the context of another form, the polymer blend is an ethylene/propylene/diene rubber (EPDM)-trans-polyoctenamer (TOR) polymer blend. In this connection, the ratio by weight of ethylene/propylene/diene rubber to trans-polyoctenamer in the polymer blend can for example lie in a region from 50:50 or 55:45 or 60:40 to 95:5 or 90:10.

In the context of another form, the polymer blend is an ethylene/propylene/diene rubber (EPDM)-polyisobutylene (PIB) polymer blend. In this connection, the ratio by weight of ethylene/propylene/diene rubber to polyisobutylene in the polymer blend can for example lie in a region from 50:50 or 55:45 or 60:40 to 95:5 or 90:10. The polyisobutylene can in this connection in particular exhibit a molecular weight between 20 000 g/mol and 5 000 000 g/mol. In particular, polyisobutylene with a molecular weight of ≧100 000 g/mol can be used. The processability can advantageously be improved through a fairly high molecular weight, for example of ≧100 000 g/mol.

In the context of an additional embodiment, the polyisobutylene accordingly exhibits a molecular weight of ≧100 000 g/mol.

In particular, oxidation-stabilized polyisobutylene can be used. For example, per kg of polyisobutylene, ≧100 mg/kg to ≦1100 mg/kg, for example ≧200 mg/kg to ≦800 mg/kg, in particular ≧300 mg/kg to ≦700 mg/kg, of stabilizer/antioxidant can be added for the stabilization. Use may be made, as stabilizer/antioxidant, for example, of nondiscolored stabilizers/antioxidants, for example 2,6-di(tert-butyl)-4-methylphenol (BHT).

In the context of another form, the polymer blend is an ethylene/propylene/diene rubber (EPDM)-chloroprene rubber (CR) polymer blend. In this connection, the ratio by weight of ethylene/propylene/diene rubber to chloroprene rubber in the polymer blend can for example lie in a region from 50:50 or 55:45 or 60:40 to 95:5 or 90:10.

In the context of another form, the polymer blend is a polymer blend of ethylene/propylene/diene rubber (EPDM) and butyl rubber (IIR) and/or chlorobutyl rubber (CIIR) and/or bromobutyl rubber (BIIR). In this connection, the ratio by weight of ethylene/propylene/diene rubber to butyl rubber and/or chlorobutyl rubber and/or bromobutyl rubber (in total) in the polymer blend can for example lie in a region from 50:50 or 55:45 or 60:40 to 95:5 or 90:10.

The elastomer material can furthermore comprise at least one lubricant, in particular chosen from the group consisting of graphite, polytetrafluoroethylene, molybdenum sulfide and mixtures thereof. For example, the elastomer material can comprise, per 100 parts by weight of the polymer blend, ≧1 part by weight to ≦20 parts by weight, for example ≧2 parts by weight to ≦15 parts by weight, in particular ≧3 parts by weight to ≦10 parts by weight, of lubricants.

The elastomer material can furthermore comprise at least one crosslinking agent. The crosslinking agent can be a crosslinking agent based on sulfur and/or peroxide. Preferably, the crosslinking agent is a crosslinking agent based on peroxide. Furthermore, the elastomer material can comprise one or more crosslinking accelerators and/or sulfur and/or sulfur donor(s) and/or peroxide(s) and also optionally cocrosslinking agents.

In addition, the elastomer material can comprise yet further additives, such as other plasticizers, white fillers, pigments, dyes, antidegradants, activators, such as, for example, zinc oxide, magnesium oxide and/or stearic acid, processing aids and/or moisture absorbers, such as, for example, calcium oxide.

In the context of an additional embodiment, the wiper rubber exhibits a wiper lip, a tilting web and a fastening section. In this connection, the wiper lip is in particular bonded to the tilting web and the tilting web is bonded to the fastening section. In this connection, the wiper lip can in particular exhibit a wiper lip head and a wiper lip point. In this connection, the wiper lip head can in particular be bonded to the tilting web.

The wiper rubber can be partially or completely formed from the elastomer material (EP(D)M-NOR/TOR/PIB/CR/IIR/CIIR/BIIR polymer blend elastomer material).

The wiper lip can in particular be at least partially formed from the elastomer material (EP(D)M-NOR/TOR/PIB/CR/IIR/CIIR/BIIR polymer blend elastomer material). Alternatively or additionally thereto, the tilting web and/or the fastening section can be formed from the elastomer material (EP(D)M-NOR/TOR/PIB/CR/IIR/CIIR/BIIR polymer blend elastomer material).

In the context of one embodiment, the complete wiper rubber is formed from the elastomer material (EP(D)M-NOR/TOR/PIB/CR/IIR/CIIR/BIIR polymer blend elastomer material).

In the context of another embodiment, the wiper rubber, for example the wiper lip, comprises at least one additional different elastomer material.

In this connection, the additional different elastomer material can, for example, comprise or be formed from at least one ethylene/propylene/diene rubber and/or at least one ethylene/propylene rubber, for example ethylene/propylene/diene rubber and/or ethylene/propylene rubber (EP(D)M), in particular ethylene/propylene/diene rubber, which is pure or unblended or not blended with other polymers, or comprise or be formed from a different polymer blend of at least one ethylene/propylene/diene rubber and/or at least one ethylene/propylene rubber and at least one polymer, for example chosen from the group consisting of ethylene/vinyl acetate copolymer, polynorbornene, trans-polyoctenamer, polyisobutylene, chloroprene rubber, butyl rubber, chlorobutyl rubber, bromobutyl rubber and mixtures thereof.

The additional different elastomer material can furthermore comprise carbon black, plasticizer oils, lubricants, crosslinking agents, crosslinking accelerators and/or sulfur and/or sulfur donor(s) and/or peroxide(s), cocrosslinking agents and additional additives, such as other plasticizers, white fillers, pigments, dyes, antidegradants, activators, such as, for example, zinc oxide, magnesium oxide and/or stearic acid, processing aids and/or moisture absorbers, such as, for example, calcium oxide. With regard to specific embodiments of the additional elastomer material, reference is herewith explicitly made to the embodiments explained in connection with the EP(D)M-NOR/TOR/PIB/CR/IIR/CIIR/BIIR polymer blend or elastomer material.

The additional different elastomer material can, for example, differ through the polymer types and/or the polymer contents and/or the additives and/or the mass ratios thereof present therein.

If the additional different elastomer material comprises a different polymer blend, this can thus differ, for example, through different ethylene/propylene/diene rubbers and/or ethylene/propylene rubbers, for example with different ethylene contents and/or propylene contents and/or termonomer contents and/or termonomers, for example chosen from the group consisting of ethylidenenorbornene (ENB), vinylnorbornene (VNB), dicyclopentadiene (DCP), 1,4-hexadiene and mixtures thereof, and/or through different polymer types, chosen from the group consisting of ethylene/vinyl acetate copolymer, polynorbornene, trans-polyoctenamer, polyisobutylene, chloroprene rubber, butyl rubber, chlorobutyl rubber and bromobutyl rubber, and/or optionally through two or more different polymers of the same polymer type from the group consisting of ethylene/vinyl acetate copolymer, polynorbornene, trans-polyoctenamer, polyisobutylene, chloroprene rubber, butyl rubber, chlorobutyl rubber and bromobutyl rubber.

In the context of a specific form, the additional different elastomer material comprises at least one ethylene/propylene/diene rubber and/or at least one ethylene/propylene rubber, for example ethylene/propylene/diene rubber and/or ethylene/propylene rubber (EP(D)M), in particular ethylene/propylene/diene rubber, which is pure or unblended or not blended with other polymers, or is formed therefrom.

In the context of another specific form, the additional different elastomer material comprises a different polymer blend of at least one ethylene/propylene/diene rubber (EPDM) and/or at least one ethylene/propylene rubber (EPM) and at least one polymer chosen from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof, or is formed therefrom.

In the context of another specific form, the additional different elastomer material comprises a polymer blend of at least one ethylene/propylene/diene rubber (EPDM) and/or at least one ethylene/propylene rubber (EPM) and at least one ethylene/vinyl acetate copolymer (EVM) or is formed therefrom.

A polymer blend which comprises at least one ethylene/propylene/diene rubber (EPDM) and/or at least one ethylene/propylene rubber (EPM) and at least one ethylene/vinyl acetate copolymer (EVM) is subsequently also described as ethylene/propylene/(diene) rubber-ethylene/vinyl acetate copolymer polymer blend or EP(D)M-EVM polymer blend or EVM polymer blend.

Advantageously, running noises, such as whistles, squeaks, squelches, flipover noises, and the like, can additionally be minimized or even avoided by using in addition an elastomer material based on EP(D)M-EVM polymer blend and/or by arranging the polymer blend as EP(D)M-NOR/TOR/PIB/CR/IIR/CIIR/BIIR-EVM polymer blend.

The EVM polymer blend can in particular comprise at least one ethylene/vinyl acetate copolymer with a vinyl acetate content in a region from ≧45% by weight to ≦85% by weight, based on the total weight of the ethylene/vinyl acetate copolymer. Advantageously, running noises, such as whistles, squeaks, squelches, flipover noises, and the like, can additionally be minimized or even avoided by additionally using an elastomer material based on an EVM polymer blend with an abovementioned vinyl acetate content.

The noise-reducing effects is presumably due to a kind of deadening introduced into the elastomer material by the ethylene/vinyl acetate copolymer. It has turned out that, in this connection, the noise-reducing effect is dependent on the vinyl acetate content of the ethylene/vinyl acetate copolymer. To achieve the noise-reducing effect, it has in this connected proven to be advantageous for the ethylene/vinyl acetate copolymer to exhibit a vinyl acetate content of at least ≧45% by weight, based on the total weight of the ethylene/vinyl acetate copolymer. On the other hand, it has turned out that the low-temperature flexibility and accordingly the running properties of the wiper rubber are also dependent on the vinyl acetate content of the ethylene/vinyl acetate copolymer. With regard to the low-temperature flexibility and running properties, it has in this connection proven to be advantageous for the vinyl acetate content of the ethylene/vinyl acetate copolymer to be ≦85% by weight, based on the total weight of the ethylene/vinyl acetate copolymer.

The EVM polymer blend can, for example, comprise at least one ethylene/vinyl acetate copolymer with a vinyl acetate content of ≧50% by weight to ≦85% by weight or ≦80% by weight, based on the total weight of ethylene/vinyl acetate copolymer. In particular, the EVM polymer blend can comprise at least one ethylene/vinyl acetate copolymer with a vinyl acetate content of ≧55% by weight or ≧60% by weight to ≦85% by weight or ≦80% by weight or ≦75% by weight, based on the total weight of the ethylene/vinyl acetate copolymer. Such vinyl acetate contents have proven to be particularly advantageous with regard to the noise-reducing effect and the low-temperature flexibility and accordingly also the running properties of the wiper rubber.

For example, the EVM polymer blend can comprise two or more (different) ethylene/propylene/diene rubbers and/or two or more (different) ethylene/propylene rubbers, for example with different ethylene contents and/or propylene contents and/or termonomer contents and/or termonomers, for example chosen from the group consisting of ethylidenenorbornene (ENB), vinylnorbornene (VNB), dicyclopentadiene (DCP), 1,4-hexadiene and mixtures thereof.

Alternatively or additionally thereto, the EVM polymer blend can comprise two or more ethylene/vinyl acetate copolymers, for example with different vinyl acetate contents and/or ethylene contents. If the polymer blend comprises ethylene/vinyl acetate copolymers with different vinyl acetate contents, in particular all ethylene/vinyl acetate copolymers can exhibit vinyl acetate contents in an abovementioned region.

In addition to ethylene/propylene/diene rubber(s) and/or ethylene/propylene rubber(s) and ethylene/vinyl acetate copolymer(s), the EVM polymer blend can in principle furthermore comprise yet one or more other polymers, for example chosen from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof.

However, it is also possible for the EVM polymer blend to be formed from ethylene/propylene/diene rubber(s) and/or ethylene/propylene rubber(s) and ethylene/vinyl acetate copolymer(s).

The EVM polymer blend can consequently in principle be a polymer blend which comprises at least one ethylene/propylene/diene rubber and/or at least one ethylene/propylene rubber and at least one ethylene/vinyl acetate copolymer or is formed therefrom, or which comprises at least one ethylene/propylene/diene rubber and at least one ethylene/vinyl acetate copolymer or is formed therefrom, or which comprises at least one ethylene/propylene rubber and at least one ethylene/vinyl acetate copolymer or is formed therefrom.

In particular, the EVM polymer blend can be a polymer blend of at least one ethylene/propylene/diene rubber (EPDM) and at least one ethylene/vinyl acetate copolymer (EVM). For example, the EVM polymer blend can be a polymer blend (EPDM-EVM polymer blend) which is formed from at least one ethylene/propylene/diene rubber (EPDM) and at least one ethylene/vinyl acetate copolymer (EVM). A fairly high degree of crosslinking can advantageously be achieved through ethylene/propylene/diene rubber (EPDM). In addition, ethylene/propylene/diene rubber (EPDM) can advantageously be crosslinked through peroxides and through sulfur and can exhibit a good processability.

The EVM polymer blend can, for example, based on the total weight of the polymers in the polymer blend, comprise from ≧10% by weight to ≦95% by weight, for example from ≧30% by weight to ≦80% by weight, of ethylene/propylene/diene rubber and/or ethylene/propylene rubber (in total), in particular ethylene/propylene/diene rubber (in total). Based on the total weight of the polymers in the polymer blend, the EVM polymer blend can comprise, for example, from ≧5% by weight to ≦90% by weight, in particular from ≧20% by weight to ≦70% by weight, of ethylene/vinyl acetate copolymer (in total). The ratio by weight of ethylene/propylene/diene rubber and/or ethylene/propylene rubber (in total), in particular of ethylene/propylene/diene rubber (in total), to ethylene/vinyl acetate copolymer (in total) can be, in the polymer blend, for example, in a region from 90:10 to 5:95, for example in a region from 70:30 to 20:80.

The EVM polymer blend can, for example, based on the total weight of the polymers in the polymer blend, comprise from ≧30% by weight to ≦60% by weight of ethylene/vinyl acetate copolymer (in total). In particular, the EVM polymer blend can, based on the total weight of the polymers in the polymer blend, comprise from ≧35% by weight to ≦55% by weight of ethylene/vinyl acetate copolymer (in total). Such ethylene/vinyl acetate copolymer contents have proven to be particularly advantageous with regard to the noise-reducing effect and the dimensional stability, in particular the heat resistance, of the wiper rubber.

In particular, the EVM polymer blend can, in this connection, based on the total weight of the polymers in the polymer blend, comprise from ≧40% by weight to ≦70% by weight, for example from ≧45% by weight to ≦65% by weight, of ethylene/propylene/diene rubber and/or ethylene/propylene rubber (in total), in particular ethylene/propylene/diene rubber (in total).

The ratio by weight of ethylene/propylene/diene rubber and/or ethylene/propylene rubber (in total), in particular ethylene/propylene/diene rubber (in total), to ethylene/vinyl acetate copolymer (in total) can, in the EVM polymer blend, for example, be in a region from 70:30 to 40:60. In particular, the ratio by weight of ethylene/propylene/diene rubber and/or ethylene/propylene rubber (in total), in particular ethylene/propylene/diene rubber (in total), to ethylene/vinyl acetate copolymer (in total) in the EVM polymer blend can be in a region from 65:35 to 45:55. Such ratios by weight have, inter alia, proven to be particularly advantageous in guaranteeing a good phase interaction.

In the context of one form, the wiper lip is partially or completely formed from a different elastomer material than the tilting web and optionally the fastening section. In particular, in this connection, the wiper lip point can be formed from a different elastomer material than the tilting web and optionally the fastening section. The wiper lip head can, in this connection, be at least partially formed from the same elastomer material as the tilting web and optionally the fastening section and optionally at least partially from the same elastomer material as the wiper lip point.

In the context of an alternative form of this form, the elastomer material of the wiper lip, in particular of the wiper lip point, is optimized with regard to deadening and noise minimization associated therewith, whereas the elastomer material of the tilting web and optionally of the fastening section and also optionally of the wiper lip head can be optimized with regard to another property, for example the low-temperature flexibility and/or heat resistance.

In this connection, the elastomer material of the wiper lip, in particular of the wiper lip point, can comprise an EP(D)M-NOR/TOR/PIB/CR/IIR/CIIR/BIIR polymer blend. The elastomer material of the tilting web and optionally fastening section and also optionally of the wiper lip head can, in this connection, comprise a polymer material different from the elastomer material of the wiper lip, for example ethylene/propylene/diene rubber and/or ethylene/propylene rubber (EP(D)M), in particular ethylene/propylene/diene rubber, which is pure or unblended or not blended with other polymers, or an EP(D)M-EVM polymer blend or an EP(D)M-NOR/TOR/PIB/CR/IIR/CIIR/BIIR-EVM polymer blend.

Through the use of an EP(D)M-NOR/TOR/PIB/CR/IIR/CIIR/BIIR polymer blend in the wiper lip, in particular wiper lip point, a deadening and noise minimization associated therewith in this connection can advantageously be achieved through the wiper lip, in particular wiper lip point.

Because the tilting web and optionally the fastening section and also optionally the wiper lip head comprise, for example, ethylene/propylene/diene rubber and/or ethylene/propylene rubber (EP(D)M), in particular ethylene/propylene/diene rubber, which is pure or unblended or not blended with other polymers, or an EP(D)M-EVM polymer blend or a EP(D)M-NOR/TOR/PIB/CR/IIR/CIIR/BIIR-EVM polymer blend, in particular with a low vinyl acetate content, the low-temperature flexibility and/or heat resistance can likewise advantageously be improved.

In the context of another opposite alternative form of this form, the elastomer material of the tilting web and/or of the fastening section and/or of the wiper lip head is optimized with regard to deadening and noise minimization associated therewith and optionally low-temperature flexibility and/or heat resistance, whereas the elastomer material of the wiper lip, in particular of the wiper lip point, can be optimized with regard to another property, for example friction.

In this connection, the elastomer material of the tilting web and optionally fastening section and also optionally of the wiper lip head can comprise an EP(D)M-NOR/TOR/PIB/CR/IIR/CIIR/BIIR polymer blend. The elastomer material of the wiper lip, in particular of the wiper lip point, can in this connection comprise a polymer material different from the elastomer material of the wiper lip, for example ethylene/propylene/diene rubber and/or ethylene/propylene rubber (EP(D)M), in particular ethylene/propylene/diene rubber, which is pure or unblended or not blended with other polymers, or an EP(D)M-EVM polymer blend or an EP(D)M-NOR/TOR/PIB/CR/IIR/CIIR/BIIR-EVM polymer blend.

Through the use of the EP(D)M-NOR/TOR/PIB/CR/IIR/CIIR/BIIR polymer blend in the tilting web and optionally the fastening section and also optionally the wiper lip head, a deadening and associated therewith a noise minimization can in this connection advantageously be achieved through the tilting web and optionally fastening section and also optionally wiper lip head.

The elastomer material of the wiper lip, in particular of the wiper lip point, can in this connection comprise another polymer material, for example ethylene/propylene/diene rubber and/or ethylene/propylene rubber (EP(D)M), in particular ethylene/propylene/diene rubber, which is pure or unblended or not blended with other polymers, or an EP(D)M-EVM polymer blend or an EP(D)M-NOR/TOR/PIB/CR/IIR/CIIR/BIIR-EVM polymer blend.

With regard to further technical features and advantages of the wiper rubber according to the invention, reference is herewith explicitly made to the explanations in connection with the elastomer material according to the invention and the windshield wiper according to the invention, and also to the figures and the description of the figures.

An additional subject matter is an elastomer material for a wiper rubber, in particular for a windshield wiper, for example of a motor vehicle, which can be obtained by mixing at least one ethylene/propylene/diene rubber and/or at least one ethylene/propylene rubber and at least one polymer chosen from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof to give a polymer blend, and also a corresponding manufacturing process.

In this connection, the at least one ethylene/propylene/diene rubber and/or the at least one ethylene/propylene rubber and the at least one polymer can be used in particular in a ratio by weight of ethylene/propylene/diene rubber and/or ethylene/propylene rubber (in total), in particular ethylene/propylene/diene rubber (in total), to the at least one polymer, in particular the total weight of the at least one polymer, in a region from 40:60 to 95:5.

In the context of one embodiment, polynorbornene is used as polynorbornene/oil mixture.

In the context of an additional embodiment, at least one plasticizer oil with a pour point in a region from ≧−25° C. to ≦+25° C. is used as oil of the polynorbornene/oil mixture and/or, on top of that, at least one plasticizer oil, in particular with a pour point in a region of ≧−25° C. to ≦+25° C. is added.

In particular, in this connection, per 100 parts by weight of the polymer blend (EP(D)M-NOR/TOR/PIB/CR/IIR/CIIR/BIIR polymer blend) ≧5 parts by weight to ≦80 parts by weight of (plasticizer) oil can altogether be used.

In the context of an additional embodiment, carbon black is furthermore added. In particular, in this connection, per 100 parts by weight of the polymer blend (EP(D)M-NOR/TOR/PIB/CR/IIR/CIIR/BIIR polymer blend), from ≧30 parts by weight or ≧35 parts by weight to ≦90 parts by weight or ≦85 parts by weight or ≦80 parts by weight or ≦75 parts by weight of carbon black can be added. The ratio by weight of carbon black to (plasticizer) oil can in this connection lie in particular in a region from 90:10 to 50:50.

In addition, the elastomer material (EP(D)M-NOR/TOR/PIB/CR/IIR/CIIR/BIIR polymer blend elastomer material) can comprise lubricants, crosslinking agents, crosslinking accelerators, sulfur and/or sulfur donor(s) and/or peroxide(s), cocrosslinking agents, other plasticizers, white fillers, pigments, dyes, antidegradants, activators, such as, for example, zinc oxide, magnesium oxide and/or stearic acid, processing aids and/or moisture absorbers, such as, for example, calcium oxide.

With regard to further technical features and advantages of the elastomer material according to the invention, reference is herewith explicitly made to the explanations in connection with the wiper rubber according to the invention and the windshield wiper according to the invention, and also to the figures and the description of the figures.

Furthermore, the invention relates to a windshield wiper which comprises a wiper rubber according to the invention and/or an elastomer material according to the invention.

With regard to further technical features and advantages of the windshield wiper according to the invention, reference is herewith explicitly made to the explanations in connection with the wiper rubber according to the invention and the elastomer material according to the invention, and also to the figures and the description of the figures.

### BRIEF DESCRIPTION OF THE DRAWINGS

Additional advantages and additional forms of the subject matters according to the invention are illustrated by the drawings and examples and explained in the following description. It should be taken into consideration, in this connection, that the drawings have only a descriptive nature and are not intended to restrict the invention in any way.

FIG. 1 shows a diagrammatic cross section through a first embodiment of a wiper rubber according to the invention;

FIG. 2 shows a diagrammatic cross section through a second embodiment of a wiper rubber according to the invention;

FIG. 3 shows a diagrammatic cross section through a third embodiment of a wiper rubber according to the invention;

FIG. 4 shows a diagrammatic cross section through a fourth embodiment of a wiper rubber according to the invention; and

FIG. 5 shows a diagrammatic cross section through a fifth embodiment of a wiper rubber according to the invention.

### DETAILED DESCRIPTION

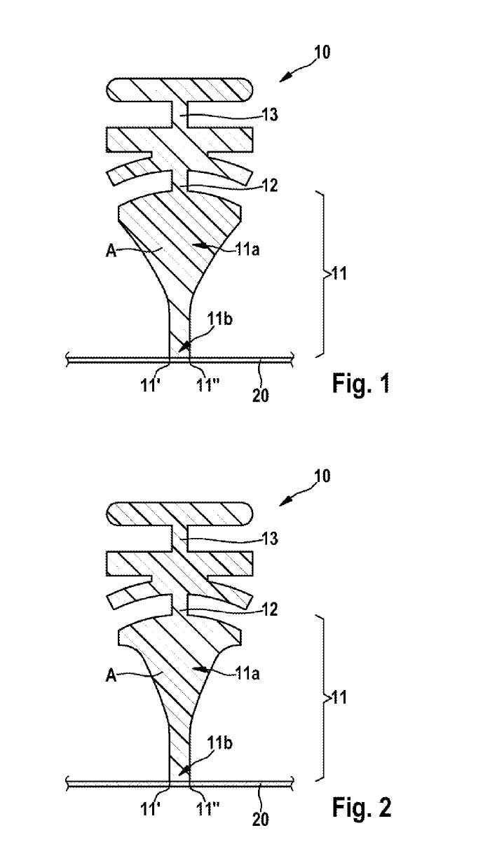

FIGS. 1 to 5 illustrate that the embodiments of wiper rubbers 10 shown therein each exhibit a wiper lip 11, a tilting web 12 and a fastening section 13. The wiper lip 11 has in this connection a wiper lip head 11a and a wiper lip point 11b. The wiper lip point 11b exhibits in this connection two wiping edges 11′, 11″ which, during the wiping movement, sweep over the windshield 20 to be wiped and in doing so push water from the windshield 20. The wiper lip point 11b is connected to the wiper lip head 11a, which 11a in turn is connected via the tilting web 12 to the fastening section 13, so that the entire wiper lip 11 can be tilted about the tilting web 12 during the wiping movement.

With the embodiments shown in FIGS. 1 to 3, the complete wiper rubber 10 is formed from an elastomer material A which comprises a polymer blend of at least one ethylene/propylene/diene rubber (EPDM) and/or at least one ethylene/propylene rubber (EPM) and at least one polymer chosen from the group consisting of polynorbornene (NOR), trans-polyoctenamer (TOR), polyisobutylene (PIB), chloroprene rubber (CR), butyl rubber (IIR), chlorobutyl rubber (CIIR), bromobutyl rubber (BIIR) and mixtures thereof.

The embodiment shown in FIG. 2 essentially differs from the embodiment shown in FIG. 1 by the wiper lip head 11a tapering more strongly in the direction of the wiper lip point 11b than in the embodiment shown in FIG. 1.

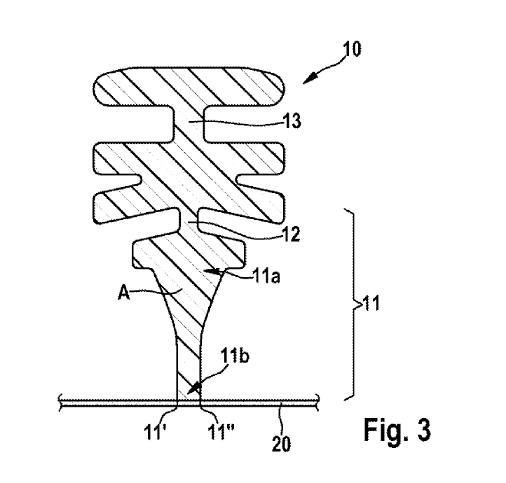

The embodiment shown in FIG. 3 essentially differs from the embodiment shown in FIG. 2 by the wiper lip head 11a being narrower and the wiper lip 11 being altogether shorter or lower than in the embodiment shown in FIG. 2.

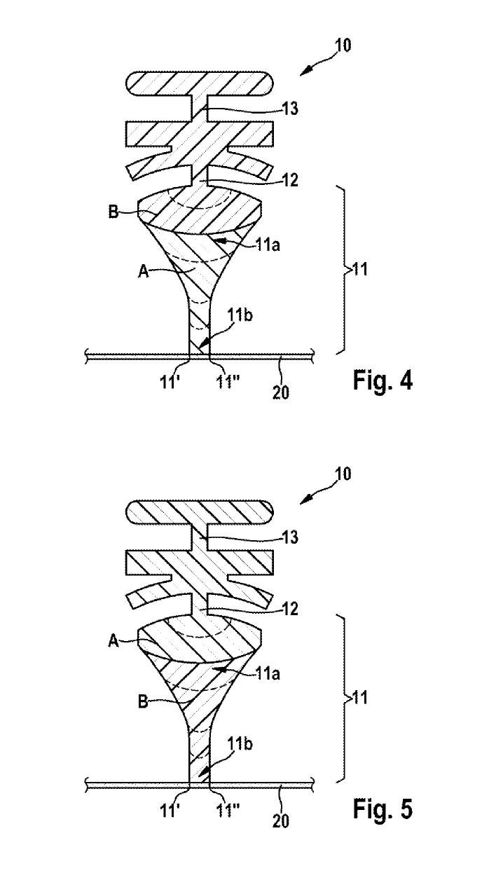

With the embodiments shown in FIGS. 4 and 5, the wiper rubber 10 is formed from two different elastomer materials A, B. With the embodiment shown in FIG. 4, the wiper lip point 11b is formed from the elastomer material A and the wiper lip head 11a, the tilting web 12 and the fastening section 13 are formed from an additional elastomer material B. Contrary thereto, in the embodiment shown in FIG. 5, the wiper lip head 11a, the tilting web 12 and the fastening section 13 are made from the elastomer material A and the wiper lip point 11b is made from the additional different elastomer material B. The broken lines indicate that the connection region between the elastomer material A and the elastomer material B can also be formed closer to the wiper lip point 11b or nearer to the tilting web 12. Depending upon the embodiment, it is possible, in this connection, for only a portion of the wiper lip point 11b to be formed from the elastomer material A, B and for the other portion of the wiper lip point 11b, together with the wiper lip head 11a, the tilting web 12 and the fastening section 13 to be formed from the additional different elastomer material B, A; or for the wiper lip point 11b and only a portion of the wiper lip head 11a to be formed from the elastomer material A, B and for the other portion of the wiper lip head 11a, together with the tilting web 12 and the fastening section 13, to be formed from the additional different elastomer material B, A.

With the embodiments shown in FIGS. 4 and 5, the elastomer material A, just like the elastomer material A of the embodiments shown in FIGS. 1 to 3, comprises an EP(D)M-NOR/TOR/PIB/CR/IIR/CIIR/BIIR polymer blend. The additional elastomer component B can, in this connection, for example be ethylene/propylene/diene rubber (EPDM) and/or ethylene/propylene rubber (EPM) or an EP(D)M-EVM polymer blend or an (EP(D)M-NOR/TOR/PIB/CR/IIR/CIIR/BIIR-EVM polymer blend.

1. A wiper rubber, comprising an elastomer material which comprises a polymer blend of at least one ethylene/propylene/diene rubber and/or at least one ethylene/propylene rubber and at least one polymer chosen from the group consisting of polynorbornene, trans-polyoctenamer, polyisobutylene, chloroprene rubber, butyl rubber, chlorobutyl rubber, bromobutyl rubber and mixtures thereof,
in which, in the polymer blend, the ratio by weight of ethylene/propylene/diene rubber and/or ethylene/propylene rubber to the at least one polymer lies in a region from 40:60 to 95:5.

2. The wiper rubber (10) as claimed in claim 1, in which, in the polymer blend, the ratio by weight of ethylene/propylene/diene rubber and/or ethylene/propylene rubber to the at least one polymer lies in a region from 50:50 to 95:5.

3. The wiper rubber (10) as claimed in claim 1, in which the polynorbornene is a polynorbornene/oil mixture.

4. The wiper rubber (10) as claimed in claim 1, in which the polyisobutylene exhibits a molecular weight of ≧100 000 g/mol.

5. The wiper rubber (10) as claimed in claim 1, in which the polymer blend is a polymer blend of at least one ethylene/propylene/diene rubber and at least one polymer chosen from the group consisting of polynorbornene, trans-polyoctenamer, polyisobutylene, chloroprene rubber, butyl rubber, chlorobutyl rubber, bromobutyl rubber and mixtures thereof.

6. The wiper rubber (10) as claimed in claim 1, in which the at least one polymer is chosen from the group consisting of polynorbornene, trans-polyoctenamer, polyisobutylene and mixtures thereof.

7. The wiper rubber (10) as claimed in claim 1, in which the elastomer material (A) furthermore comprises carbon black.

8. The wiper rubber (10) as claimed in claim 1, in which the elastomer material (A) furthermore exhibits at least one plasticizer oil with a pour point in a region from ≧−25° C. to ≦+25° C.

9. The wiper rubber (10) as claimed in claim 1, the wiper rubber (10) exhibiting a wiper lip (11), a tilting web (12) and a fastening section (13), the wiper lip (11) being bonded to the tilting web (12) and the tilting web (12) being bonded to the fastening section (13),
the wiper lip (11) being at least partially formed from the elastomer material (A), and/or the tilting web (12) and/or the fastening section (13) being formed from the elastomer material (A).

10. The wiper rubber (10) as claimed in claim 1, the wiper rubber (10) comprising at least one additional elastomer material (B).

11. An elastomer material (A) for a wiper rubber (10), obtained by mixing at least one ethylene/propylene/diene rubber and/or at least one ethylene/propylene rubber and at least one polymer chosen from the group consisting of polynorbornene, trans-polyoctenamer, polyisobutylene, chloroprene rubber, butyl rubber, chlorobutyl rubber, bromobutyl rubber and mixtures thereof to give a polymer blend, in which the at least one ethylene/propylene/diene rubber and/or the at least one ethylene/propylene rubber and the at least one polymer are used in a ratio by weight of ethylene/propylene/diene rubber and/or ethylene/propylene rubber to the at least one polymer in a region from 40:60 to 95:5.

12. The elastomer material (A) as claimed in claim 11, the polynorbornene being used as polynorbornene/oil mixture.

13. The elastomer material (A) as claimed in claim 11, the oil of the polynorbornene/oil mixture being a plasticizer oil with a pour point in a region from ≧−25° C. to ≦+25° C. and/or at least one plasticizer oil.

14. The elastomer material (A) as claimed in claim 11, carbon black furthermore being added.

15. A windshield wiper, comprising a wiper rubber (10) as claimed in claim 1.

16. An elastomer material as claimed in claim 11.

17. The wiper rubber (10) as claimed in claim 1, in which the polynorbornene is a polynorbornene/oil mixture in which the oil of the polynorbornene/oil mixture is a plasticizer oil or plasticizer oil mixture with a pour point in a region from ≧−25° C. to ≦+25° C.

18. The wiper rubber (10) as claimed in claim 1, in which the elastomer material (A) furthermore comprises carbon black, in which the elastomer material (A) comprises, per 100 parts by weight of the polymer blend, from 30 parts by weight to ≦90 parts by weight of carbon black.

19. The wiper rubber (10) as claimed in claim 1, in which the elastomer material (A) furthermore exhibits at least one plasticizer oil with a pour point in a region from ≧−25° C. to ≦+25° C., in which the elastomer material (A) comprises, per 100 parts by weight of the polymer blend, ≧5 parts by weight to ≦80 parts by weight of oil, in which the ratio by weight of carbon black to oil lies in a region from 90:10 to 50:50.

20. The wiper rubber (10) as claimed in claim 1, the wiper rubber (10) comprising at least one additional elastomer material (B), which comprises at least one ethylene/propylene/diene rubber and/or at least one ethylene/propylene rubber or a different polymer blend of at least one ethylene/propylene/diene rubber and/or at least one ethylene/propylene rubber and at least one additional polymer, chosen from the group consisting of ethylene/vinyl acetate copolymer, polynorbornene, trans-polyoctenamer, polyisobutylene, chloroprene rubber, butyl rubber, chlorobutyl rubber, bromobutyl rubber and mixtures thereof.

21. The elastomer material (A) as claimed in claim 11, the oil of the polynorbornene/oil mixture being a plasticizer oil with a pour point in a region from ≧−25° C. to ≦+25° C. and/or at least one plasticizer oil, with a pour point in a region from ≧−25° C. to ≦+25° C., furthermore being added, per 100 parts by weight of the polymer blend, ≧5 parts by weight to ≦80 parts by weight of oil altogether being used.

22. The elastomer material (A) as claimed in claim 11, carbon black furthermore being added, per 100 parts by weight of the polymer blend, from ≧30 parts by weight to ≦90 parts by weight of carbon black being added, the ratio by weight of carbon black to oil lying in a region from 90:10 to 50:50.
